(19) United States
(12) Patent Application Publication
(10) Pub. No.: US 2012/0294725 A1
(43) Pub. Date: Nov. 22, 2012

(54) ROTOR DISK

(75) Inventors: Manfred Hackl, Linz-Urfahr (AT); Klaus Feichtinger, Linz (AT); Gerhard Wendelin, Linz (AT)

(73) Assignee: EREMA Engineering Recycling Maschinen und Anlagen Gesellschaft m.b.H., Ansfelden (AT)

(21) Appl. No.: 13/521,580

(22) PCT Filed: Jan. 7, 2011
(86) PCT No.: PCT/AT11/00004

§ 371 Date: Jul. 11, 2012

(30) Foreign Application Priority Data
Jan. 14, 2010 (AT) A 43/2010

(51) Int. Cl. B01F 7/00

(52) U.S. Cl. 416/223 R

(57) ABSTRACT

Disclosed is a rotor disk (1) to be inserted into a receptacle (2) for the treatment of polymers, having a disk body (3) on whose top side (4) mixing and/or comminuting tools (5) are provided and on whose opposite underside (6) a number of conveying ribs (7) extending from the interior to the exterior are provided with which during operation polymer particles are transportable towards the exterior or, respectively, that during operation exert a force directed from the center (8) of the rotor disk (1) towards the exterior on the polymer particles grasped by the conveying ribs (7). The conveying ribs (7) are equipped with a conveying surface aligned straight and essentially vertically to the underside in the direction of rotation or, respectively, of movement or, respectively, equipped with a shoulder surface sloping towards downstream relative to the direction of movement or, respectively, have an essentially triangular cross section.

The invention relates to a rotor disk in accordance with the preamble of claim 1

Such rotor disks in various designs have been known from the state of the art. They are most often arranged near the bottom of a receptacle or, respectively, of a cutter compactor for the processing and conditioning of thermoplastic polymers and essentially consist of a disk-shaped tool carrier at whose top side mixing or, respectively, stirring tools or comminutors are arranged. During operation, the disk revolves and the tools will grasp and, if necessary, comminute the synthetic material fed into the container while simultaneously heating it. In addition, the material is being stirred and constantly moved to the effect that a mixing vortex will form in the container.

In general, devices for the processing of polymers have also been known from the state of the art, for example from AT 375 867 B, AT 407 970 B or WO 93/18902. Due to the revolving tool carriers or, respectively, the tools, the treated synthetic material is hurled against the lateral wall of the container through the effect of centrifugal force. A portion of the synthetic material rises up along the lateral wall of the container and revolves in the form of a mixing vortex but will ultimately fall back into the center of the container. This will result in the desired retention time of the treated synthetic particles in the receptacle so that the synthetic material fed into it will be thoroughly mixed, sufficiently heated by the friction forces and, in the case of tools acting in comminuting fashion on the synthetic material, sufficiently comminuted.

However, it has shown that not the entire amount of synthetic material hurled against the lateral wall of the container rises up on said wall but that a portion will end up below the lowest tool or, respectively, below the lowest disk forming the tool carrier. There, the synthetic portion may fuse in uncontrolled fashion due to the friction effect.

Attempts have been made to avoid this disadvantage through the attachment of conveying ribs to the underside of this disk. From the state of the art, it has been known with regard thereto to attach to the underside of the disk or, respectively, of the tool carrier straight and radial ribs that serve to transport any synthetic material that ends up between the bottom of the cutter compactor and the underside of the tool carrier back towards the exterior and to remove it again from that area.

However, this measure has not been entirely satisfactory. In particular in the case of large-dimensioned receptacles and a correspondingly great filling volume of several hundred kilograms of polymer material, correspondingly large disks with large diameters must be employed. These disks must, on the one hand, be manufactured with great precision and also rotate very quietly and regularly since the distance between the disk and the bottom amounts to only a few millimeters. In such large-dimensioned cutter compactors, great demands are made on the transportation effect of the ribs since, as mentioned before, a great amount of material to be treated is present in the container that, on the one hand, is to be moved and that, on the other hand, exerts great downward pressure due its great own weight, forcing itself into the space between the disk and the bottom.

During the upscaling of such devices it has shown that the conveying capability of the known disks that work sufficiently in the case of small containers will no longer suffice in the case of large containers in order to keep the material away from the problem area. Nor can the rotational speed of the mixing tools used to give the material an upward movement and to increase the retention time be increased at will since due to the generated friction, more heat would be produced that could lead to a local fusion of the flakes.

Again and again, polymer flakes will then end up in the exterior area between the bottom and the disk and remain there permanently. This will increase the temperature in this area, the flakes will agglomerate, becoming gluey and possibly melting, leading to even more flakes accumulating. After some time, the disk will begin to rattle and ultimately jam. Therefore, it is desirable that in the event that at some time a particle does become wedged between the ribs and the container bottom, this particle will be swiftly freed and subsequently be effectively removed again from the critical area.

Moreover, not only larger flakes but also smaller dust particles end up in the critical area below the disk, with the dust particles penetrating even further in the direction of the center of the disk and remaining there. These fine polymer particles will then be heated too much as well and be isolated and caught in the critical area.

In general, this is problematic in the case of disks with a smaller diameter as well since, in particular in the case of heavy grist loads, lower rotational speeds, i.e. relatively low circumferential speeds, are being used.

It is therefore the objective of the invention at hand to create a rotor disk that, in particular in the case of a high filling volume and large dimensions, effectively prevents polymer particles from ending up in the critical area between the disk and the bottom of the receptacle or, respectively, that frees and removes them from this area swiftly and completely.

This objective is met by the characterizing features of claim 1 which provide that the conveying ribs are equipped with a conveying surface aligned straight and essentially vertically to the underside in the direction of rotation or, respectively, of movement or, respectively, equipped with a shoulder surface sloping towards downstream relative to the direction of movement or, respectively, have an essentially triangular cross section.

In this way it is effectively prevented that during the treatment and conditioning of synthetic particles, even at a great filling volume and correspondingly high downward pressure, especially larger and coarser polymer flakes can wedge themselves between the bottom and the disk, thereby jamming the disk. If in spite of that particles are in danger of remaining in the small space between the bottom and the disk underside longer than intended, wedging themselves there briefly, they will be easily freed through the sloping shoulder surface and transported away towards the exterior.

In this way, the critical area will remain permanently free of such particles. This makes an effective and homogeneous processing of the polymer material present in the receptacle possible. In addition, holding times and repair periods caused by a jamming of the disk will be avoided. Also, the quality of the material to be treated will be improved since local overheating or fusion coating are prevented.

Additional advantageous embodiments of the invention will be described by the dependent claims:

It will be particularly advantageous if the shoulder surface is aligned relative to the underside at an angle δ of 10° to 35°, in particular of about 15°.

In accordance with an advantageous further development of the invention, it is provided that the thickness of the disk body decreases by at least 1 mm, preferably between 1.5 and 3.5 mm, with this difference in the thickness of the disk body being measured in the center or, respectively, in an inner central area and at the external edge. It has surprisingly turned out that a great improvement can be achieved even with such minor changes.

A particularly advantageous embodiment provides for the height of the conveying ribs to increase in the direction of their course towards the exterior.

In this case, it will be particularly advantageous that the thickness of the disk body decreases towards the exterior in the same measure as the height of the coveying ribs increases towards the exterior or, respectively, that the overall thickness of the rotor disk across its radius remains the same and constant. This way, great running smoothness and an efficient conveyance of the polymer particles from the critical area can be achieved.

Moreover, it will be advantageous if it is provided that the thickness of the disk body is constant in an inner area, starting to decrease only at a distance from the center of the rotor disk, preferably starting at a distance of 60% of the radius, in particular between 60% and 70%. Likewise, it will be advantageous if the height of the conveyor ribs remains constant within an inner area, starting to increase only at a distance from the center of the rotor disk, preferably starting at a distance of 60% of the radius, in particular between 60% and 70%. In this case, the changes of the dimension will occur only in an outer radial area, to with where the larger flakes can still, but just barely, penetrate. In this way, coarse as well as fine particles will be efficiently transported towards the exterior.

In accordance with a preferred embodiment it is provided that the points or, respectively, areas of the coveying ribs farthest from the top side of the disk body define or, respectively, open up a level plane. Looked at from the side, the overall thickness of the rotor disk therefore remains constant.

In this context it will be advantageous if it is provided that the top side of the disk body is level flat and/or that the plane runs parallel to the top side. Such a structural design is also relatively easy to manufacture and runs very smoothly.

A particularly effective rotor disk is characterized by the fact that the underside of the disk body, in the area in which its thickness decreases, is slanted and sloped towards the top side and/or towards the plane, in particular at an angle of maximally 3°, in particular between 0.4° and 0.6°. This will result in a quasi-truncated cone-shaped design of the disk, in which case it has again surprisingly turned out that only minor deviations and angle dimensions will suffice in order to achieve an efficient removal.

A structurally simple design of an embodiment provides that the decrease of the thickness of the disk body continually runs in a plane, thereby avoiding the occurrence of turbulences and improving a smooth run.

However, a rotor disk will be just as effective if it is provided that the decrease in the thickness of the disk body proceeds discontinuously or, respectively, in steps, if necessary in one single step. Whether a continuous or discontinuous decrease is more advantageous depends, among other things, on the type, the form and the dimensions of the material to be processed, for example, if it is foils, flakes or granulate that are being recycled.

In this context it has surprisingly shown that, in order to make an even more effective conveyance towards the exterior possible, it will be advantageous if the conveying ribs are curved concavely in the direction of the rotation of the disk, thereby increasing the fan effect even further. This characteristic will synergistically support the effect of the decreased thickness and increase the effect even further. In the unlikely event that a particle penetrates farther into the critical area, for example if the treatment must be unexpectedly interrupted and the agitator must be stopped, it will be swiftly removed again.

Here, it has proved to be advantageous if the curvatures are uniform and in the shape of a circular arc.

In this context it is particularly advantageous to provide that the curvatures of all conveying ribs are the same relative to each other. The construction of such a rotor disk is very easy to design.

If it is provided that at least two groups of conveying ribs are provided that in each case start alternately at a different distance from the center, to with from an inner central area and from an outer central area, the constructive design of the disk will also be made easier since conveying ribs standing closely together will be avoided in the inner area of the disk.

It has turned out to be surprisingly advantageous for the conveying effect if the conveying ribs are not aligned radially towards the center but if the outer end sections of the conveying ribs are aligned nearly tangentially relative to the edge of the rotor disk, in particular at an outer intersecting angle between 0° and 25°, preferably between 12° and 18°.

It is equally advantageous if the inner initial sections of the conveying ribs are set, relative to the center or, respectively, to the inner central area or, respectively, to the outer central area, at inner intersecting angles β₁ or, respectively, β₂ between 0° and 45°, preferably between 15° and 30°. Here, it will be advantageous if β₂ is larger than β₁.

Each intersecting angle is measured in each case at the intersection or, respectively, at the point where the conveying rib joins the edge of the rotor disk or, respectively, the inner central area or, respectively, the outer central area. In this case, the intersecting angle will in each case be the angle between the tangent placed on the conveying rib at this intersection and the tangent placed on the inner central area or, respectively, the outer central area at this intersection.

In this context, the rotor disk rotates during operation in the direction of the concave curvature.

In order to be able to influence, via the conveyor disk, the temperature of the material to be processed, it is provided in accordance with an advantageous further development that a hollow space is formed in the disk body, if necessary filled or perfusable with a coolant.

Moreover, it is provided in accordance with the invention that the rotor disk is arranged in a cutter compactor located at a short distance from the bottom. A particularly advantageous device for the processing and conditioning of synthetic material provides to this end for a receptacle, in particular an evacuatable one, with the rotor disk in accordance with the invention being arranged near and parallel to the bottom surface. To this end, the rotor disk is advantageously supported and drivable by an essentially vertically aligned shaft, providing the synthetic material present in the receptacle with a rotational movement around the axis of the shaft.

In a particularly advantageous embodiment, the distance between the rotor disk, to with between the outermost points or, respectively edges of the coveying ribs that are the farthest away from the disk, and the bottom surface of the receptacle is smaller than the thickness of the disk body, preferably within the range between 3 and 15 mm, preferably between 4 to 8 mm.

Additional advantages and embodiments of the invention will result from the description and the enclosed drawings.

In the following, the invention will be represented in the drawings by way of a particularly advantageous embodiment and described in exemplary fashion, with references being made to the drawings.

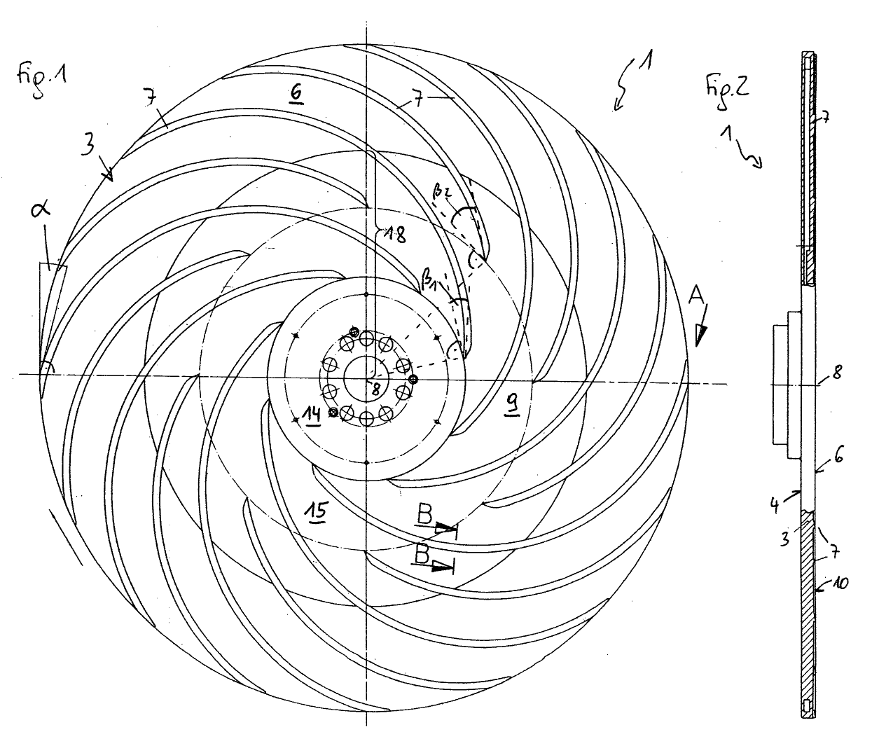

FIG. 1 shows the rotor disk in accordance with the invention from below.

FIG. 2 shows a cut view through the center of the disk in accordance with FIG. 1.

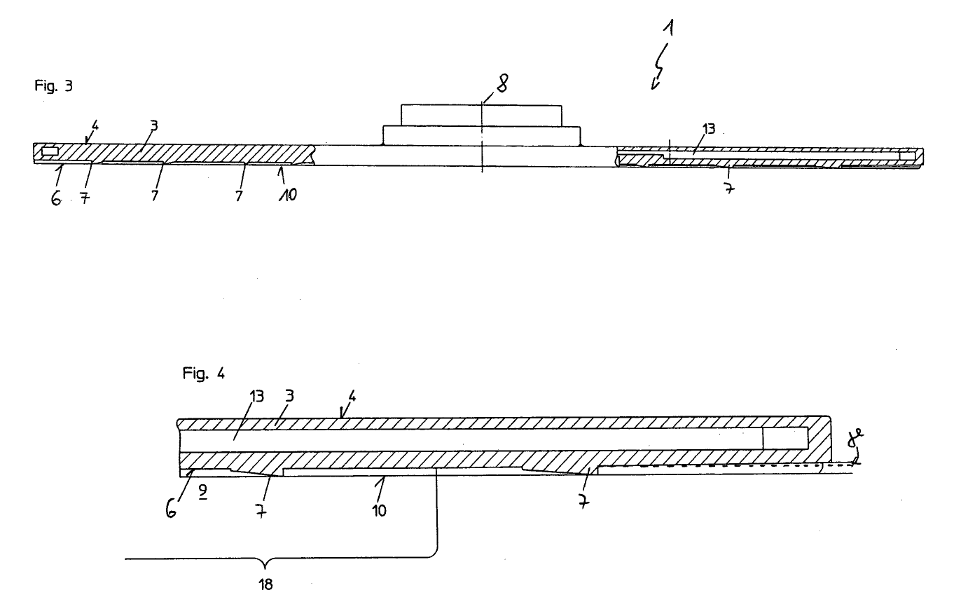

FIG. 3 shows an enlarged representation of the cut in accordance with FIG. 2.

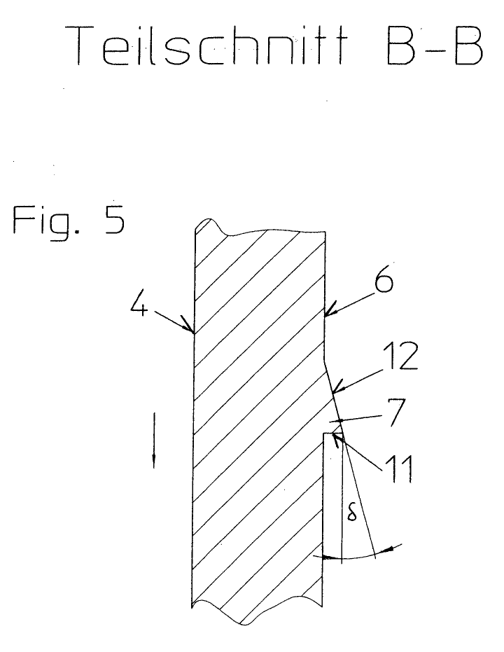

FIG. 4 shows in detail the right side of the cut in accordance with FIG. 2 or, respectively, FIG. 3.

FIG. 5 shows the partial cut B-B of FIG. 1.

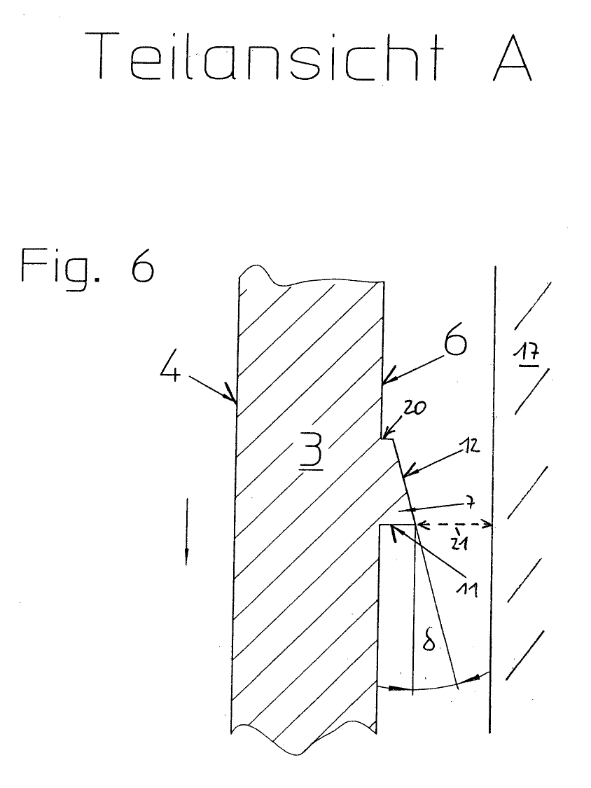

FIG. 6 shows detailed view A of FIG. 1.

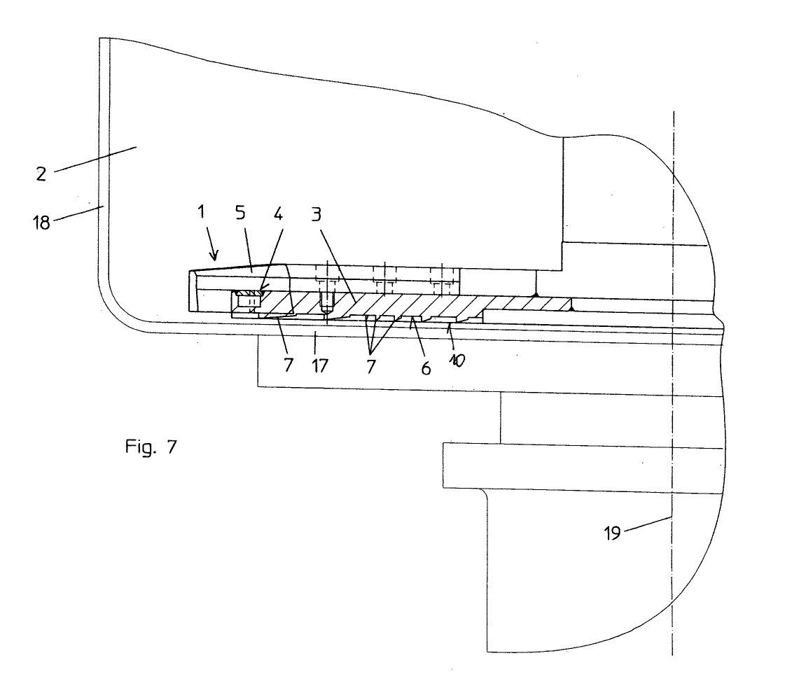

FIG. 7 shows a sectional cut of a receptacle with a disk arranged in it.

In FIG. 1, a particularly effective and advantageous rotor disk 1 is represented in exemplary fashion, with FIG. 1 showing the rotor disk from below, i.e. as seen during operation from the container bottom 17. In practice, such rotor disks 1 are most often used in large-volume receptacles 2 in which a great amount of polymer material with the corresponding great weight is present. A correspondingly great pressure rests on the rotor disk 1. In these cases, the diameter of such a rotor disk 1 lies within the range of approximately 2 m and more.

The rotor disk 1 has a disk body 3 on whose top side 4 mixing and/or comminuting tools 5 may be arranged. On the opposite underside 6 of the disk body, a number of conveying ribs 7 extending from the interior to the exterior are arranged. All conveying ribs 7 are curved concavely in the rotational direction of the disk 1, with the curvatures running uniformly in the shape of a circular arc. The curvature radius of the conveying ribs 7 is less than the radius of the rotor disk 1 and amounts to about 65% thereof Also, the curvatures of all conveying ribs are nearly identical relative to each other.

Two groups of coveying ribs 7 are provided, to with longer and shorter ones, which are arranged alternating to each other. The longer coveying ribs 7 start at an inner circular central area 14 whose radius is about 30% of the radius of the rotor disk 1. The shorter conveying ribs 7 start at an outer central area 15 whose radius is about 5% of the radius of the rotor disk 1. All conveying ribs run continuously all the way to the extreme edge of the rotor disk 1 or, respectively, of the disk body 3.

The conveying ribs 7 are not aligned radially relative to the center 8 of the rotor disk 1. For example, the outer end sections of all of all conveying ribs 7 are aligned nearly tangentially to the outer edge of the rotor disk, to with at an outer intersecting angle α of about 14° as measured at the point where the coveying rib 7 reaches the edge or, respectively, the circumference between the tangent placed at the extreme edge and the tangent placed at the coveying rib 7 where the conveying rib touches the extreme edge or, respectively, circumference.

The inner initial sections of the longer conveying ribs 7 are oriented relative to the inner central area 14 at a first inner intersecting angle β₁ of about 15°, in each case measured at the end point of the conveying rib 7 between the tangent on the inner central area 14 and the tangent on the conveying rib 7 where it or, respectively, the conveying rib 7 touches the inner central area 14.

The inner initial sections of the shorter conveying ribs 7 are oriented relative to the outer central area 15 at a second inner intersecting angle β₂ of about 35° to 40°, in each case measured at the end point of the conveying rib 7 between the tangent on the outer central area 15 and the tangent on the conveying rib 7 where it or, respectively, the conveying rib 7 touches the outer central area 15.

In this case, it will be advantageous if β₂ is greater than β₁.

In the contact area at the inner central area 14 and the outer central area 15, the conveying ribs 7 converge at an acute angle or, respectively, end there.

With conveying ribs 7 designed in that way, large as well as small polymer particles can be transported during operation toward the exterior or, respectively, a force directed towards the exterior is exerted from the center 8 of the rotor disk 7 upon the particles grasped by the conveying ribs 7. As a rule, the conveying effect is brought about by the mechanical effect of the conveying ribs 7 on the polymer particles since the treatment usually occurs in a vacuum. But treatment under ambient pressure is also possible in the same manner, with flow effects occurring in addition to the mechanical contacts between conveying ribs 7 and polymer particles.

In FIGS. 2, 3 and 4, the rotor disk 1 is represented in a cross section through the center 8. On the top side 4 of the disk body 3 facing the container during operation, mixing and/or comminuting tools 5 may be arranged. In the embodiment at hand, such tools are not shown. The mixing and/or comminuting tools 5 may involve shovels, knives or the like. They grasp the polymer particles and bring them into a rotational movement which leads to a mixing vortex forming in the container. In addition, the particles are heated and kept in a constant mixing process, thereby preventing any adhesion or, respectively, fusing even at higher temperatures. If necessary, a shredding or, respectively, comminution of larger granulates will occur as well.

The conveying ribs 7 are arranged on the underside 6 of the disk body 3. In this case, the thickness of the disk body 3 is constant and uniform within an inner area 9. This inner area 9 extends to about two thirds of the radius of the rotor disk 1. Starting at a certain distance 18 from the center 8 of the rotor disk 1, the thickness of the disk body 3 decreases. In the example at hand, the radial distance 18 amounts to about 68% of the radius of the rotor disk 1. Also starting from this radial distance 18, the height of the conveying ribs increases correspondingly towards the exterior while the height of the conveying ribs 7 is constant and uniform within the inner area 9.

From FIGS. 2 through 4 it can be seen that the thickness of the disk body 3 decreases only to a minor degree, in the embodiment at hand by a mere 2 mm. In the same manner and to the same extent, the height of the conveying ribs 7 increases as well, following their course towards the exterior so that the overall thickness of the rotor disk 1 remains the same and uniform across its entire radius. In this outer area, only the distance between the disk body 3 or, respectively, the underside 6 and the uppermost points or, respectively, ridges of the conveying ribs 7 becomes larger or, respectively, the area between the conveying ribs 7 becomes somewhat higher.

The points or, respectively, areas of the conveying ribs 7 farthest from the top side 4 form a level plane 10, with this plane 10 being aligned parallel to the likewise level top side 4 of the disk body 3.

In the example at hand, the decrease in the thickness of the disk body 3 runs continuously or, respectively, via a slanted plane. The underside 6 of the disk body 3 is slanted in the outer area in which its thickness decreases and sloped upward towards the top side 4 at an angle γ of about 0.5°. The rotor disk 1 or, respectively, the disk body 3 therefore has, in a manner of speaking, the shape of a truncated cone with a flattened exterior circumferential ridge.

In accordance with an additional possible embodiment, the thickness of the disk body 3 may also decrease continually or, respectively, via steps which entails advantages in the case of certain recycling materials.

Moreover, it is provided that at least one hollow space 13 flowed through by a coolant is formed in the interior of the disk body 3 through which a cooling effect can occur on the disk.

In FIG. 5, a cross section through a conveying rib 7 is shown. Each conveying rib 7 has an essentially triangular cross section, with a conveying surface 11 aligned level in the direction of rotation and essentially aligned vertically relative to the underside 6 and a plane shoulder surface 12 sloping downward at an angle δ between 10° and 35°, in particular about 15°, downstream relative to the direction of rotation. This achieves the effect in accordance with the invention that a particle wedged between the upper edge of the conveying rib 7 and the container bottom 17 will swiftly become free and slide off via the shoulder surface 12. This is shown in detail in FIGS. 6 and 7.

FIG. 6 shows a view of a conveying rib 7 as seen at an angle from the side of the rotor disk 1. It can be seen that the shoulder surface 12 does not transition into the underside 6 continuously, directly or, respectively, at an acute angle but rather via a ridge or, respectively, a step 20. However, the transition may also occur without a step 20.

FIG. 7 shows a rotor disk 1 in accordance with the invention during operation, to with used in a device for the treatment and conditioning of synthetic material. The lower left area of such a device is shown in FIG. 7. In this case, the rotor disk 1 is placed in an evacuatable receptacle 2 which has a level plane, a horizontal bottom surface 17 and vertical lateral walls 18. The rotor disk 1 is arranged in immediate proximity of the bottom and parallel to the bottom surface 17 and is supported by a shaft 19 essentially aligned vertically, and it can also be driven via this shaft 19. Due to the rotation of the rotor disk 1, in particular by means of the mixing tools 5, the material present in the receptacle 2 is moved and experiences, among other things, a circulatory movement around the axle of the shaft 19.

The distance 21 between the rotor disk 1, to with between the outermost points or, respectively, edges or, respectively, ridges of the conveying ribs 7 or, respectively the plane 10 farthest from the disk and the bottom surface is relatively small and lies in the range between about 5 to 6 mm The distance 21 between the bottom surface 17 and the rotor disk 1 is depicted in FIG. 6 schematically and not to scale. The disk having a diameter of about 2,000 mm usually rotates at a rotational speed of 10 to 300 revolutions per minute, e.g. at 20 to 150 rpm.

A particularly advantageous embodiment of a device is equipped with an evacuatable receptacle 2 with a circular cross section and a vertical axis into which the synthetic material, in particular of the thermoplastic kind, e.g. PRT (polyethylene terephthalate), to be processed is fed from above through a feed opening in the form of grist consisting of bottles, bottle pre-moldings, foils, flakes, etc. If the material to be processed is to be processed in a vacuum, a lock is attached to this opening whose lock chamber can be sealed by means of two sliders that can be moved back and forth by double-action cylinders. At the top, a feed funnel is attached to the lock into which the material to be processed is entered in batches or continuously by means of a feed mechanism (not shown), e.g. a conveyor belt. An evacuation line leading to an evacuation device is attached to the lock chamber. An additional evacuation line leads from the receptacle 2 to the evacuation device.

The receptacle 2 has vertical lateral walls 18 and a horizontal bottom 17. Near the bottom 17, a tool carrier is arranged which is formed by a horizontal circular rotor disk 1 resting on a shaft 19 which penetrates the bottom 17 in vacuum-tight fashion and which is driven by a motor for a rotation in the direction of the arrow. At its surface 4, the disk bears several tools 5 distributed at equal distances around the circumference of the rotor disk 1 which act on the synthetic material present in the container 2 during the rotation of the disk 1. On the one hand, this drives the synthetic material into a circulation around the axis 19, on the other hand, the centrifugal force tries to move the synthetic material in a radial direction towards the lateral wall 18. A mixing vortex is created to the effect that a portion of the synthetic material will rise up along the lateral wall 18, reaching a culmination point during this circulation and finally falling back into the area of the container axis. But not the entire amount of the synthetic material participates in this uprising because a portion of the synthetic material hurled off by the disk 1 will try to penetrate into the space below the disk 1, in particular if a lot of material is present in the container.

In order to lessen this effect to some degree, the disk 1 in the case at hand bears several shovels set at an angle and arranged in equal intervals around the circumference of the disk. These shovels impart a preferred upward movement on the synthetic material hurled off from the disk 1 by the tools 5, thereby preventing, in a way, synthetic portions from ending up in the space below the disk 1 of the tool carrier during the processing of the material in the container 2.

However, this effect is not optimized until the conveying ribs 7 in accordance with the invention are arranged on the underside 4 of the disk 1 which are arranged in such a way that the synthetic material ending up or, respectively, pressing into the critical area is transported in the direction of the lateral wall 18. The synthetic material moved towards the exterior in this fashion will then be grasped by the shovels and be transported upward again.

1. A rotor disk (1) to be inserted into a receptacle (2) for the treatment of polymers, having a disk body (3) on whose top side (4) mixing and/or comminuting tools (5) are providable and on whose opposite underside (6) a number of conveying ribs (7) extending from the interior to the exterior are provided with which during operation polymer particles are transportable towards the exterior or, respectively, that during operation exert a force directed from the center (8) of the rotor disk (1) towards the exterior on the polymer particles grasped by the conveying ribs, characterized in that the conveying ribs (7) are equipped with a conveying surface aligned straight and essentially vertically to the underside in the direction of rotation or, respectively, of movement or, respectively, equipped with a shoulder surface sloping towards downstream relative to the direction of movement or, respectively, have an essentially triangular cross section.

2. A rotor disk in accordance with claim 1, characterized in that the shoulder surface (12) is aligned at an angle δ relative to the underside (6) of 10° to 35° , in particular of about 15°.

3. A rotor disk in accordance with claim 1, characterized in that the thickness of the disk body (3) decreases towards the exterior, in particular by at least 1 mm, preferably between 1.5 to 3.5 mm

4. A rotor disk in accordance with claim 1 characterized in that the height of the conveying ribs (7) increases towards the exterior in the direction of their course.

5. A rotor disk in accordance with claim 1 characterized in that the thickness of the disk body (3) decreases towards the exterior to the same degree as the height of the conveying ribs (7) increases towards the exterior.

6. A rotor disk in accordance with claim 1 characterized in that the overall thickness of the rotor disk (1) is uniform and constant across its radius.

7. A rotor disk in accordance with claim 1 characterized in that the thickness of the disk body (3) is constant within an inner area (9) and decreases starting from a distance (18) from the center (8) of the rotor disk (1), preferably starting from a distance (18) of 60% of the radius, in particular between 60% and 70%, and/or that the height of the conveying ribs (7) is constant within an inner area (9) and increases starting from a distance (18) from the center (8) of the rotor disk (1), preferably starting from a distance (18) of 60% of the radius, in particular between 60% and 70%.

8. A rotor disk in accordance with claim 1 characterized in that the points or, respectively, sections of the conveying ribs (7) farthest from the top side (4) define or, respectively, open up a level plane (10).

9. A rotor disk in accordance with one of claims 1 through 8, claim 1 characterized in that the top side (4) of the disk body (3) is a level plane and/or that the plane (10) runs parallel to the top side (4).

10. A rotor disk in accordance with claim 1 characterized in that the underside (6) of the disk body (3) is slanted in the area where its thickness decreases and sloped towards the top side (4) and/or towards the plane (10), in particular at an angle γ of maximally 3°, in particular between 0.4° and 0.6°.

11. A rotor disk in accordance with claim 1 characterized in that the decrease of the thickness of the disk body (3) occurs continuously.

12. A rotor disk in accordance with claim 1 characterized in that the decrease of the thickness of the disk body (3) occurs discontinuously or, respectively, in steps, if necessary in one single step.

13. A rotor disk in accordance with claim 1 characterized in that the conveying ribs (7) are curved concavely in the direction of rotation.

14. A rotor disk in accordance with claim 1 characterized in that the curvatures of all conveying ribs (7) are identical relative to each other and/or that the curvatures are uniform, preferably in the shape of a circular arc.

15. A rotor disk in accordance with one claim 1 characterized in that at least two groups of conveying ribs (7) are provided that in each case start alternately at different distances from the center (8), to with from an inner central area (14) and from an outer central area (15).

16. A rotor disk in accordance with claim 1 characterized in that the outer end sections of the conveying ribs (7) are aligned nearly tangentially relative to the edge of the rotor disk (1), in particular at outer intersecting angles α between 0° and 25°, preferably between 12° and 18° and/or that the inner initial sections of the conveying ribs (7) are set, relative to the inner central area (14) or, respectively, to the outer central area (15), at first and second inner intersecting angles β₁ or, respectively, β₂ between 0° and 45°, preferably between 15° and 30°, with the second inner intersecting angles β₂ being greater than the first inner intersecting angles β₁, with the intersecting angles in each case being measured between the tangents placed on the conveying ribs (7) and the tangents placed on the edge of the rotor disk (1) or, respectively, on the inner central area (14) or, respectively, on the outer central area (15) at the intersection of these tangents or, respectively, at the end points of the conveying ribs (7).

17. A rotor disk in accordance with claim 1, characterized in that at least one hollow space (13), if necessary filled with or flowed through by a coolant, is formed in the disk body (3).

18. A device for the treatment and conditioning of synthetic material with a receptacle (2), in particular an evacuatable one, having a plane level bottom surface (17) and lateral walls (18), with a rotor disk (1) being arranged in rotatable fashion near and parallel to the bottom surface (17) in accordance with claim 1, with the rotor disk (1) being supported and drivable by an essentially vertically aligned shaft (19) so that the synthetic material present in the receptacle (2) can be set in motion.

19. A device in accordance with claim 18, characterized in that the distance between the outermost points or, respectively, edges of the conveying ribs (7) farthest from the disk or, respectively, the plane (10) and the bottom surface (17) is less than the thickness of the disk body (3) and preferably lies between 3 and 15 mm, preferably between 4 and 8 mm.
